(19) United States
(12) Patent Application Publication
(10) Pub. No.: US 2008/0175518 A1
(43) Pub. Date: Jul. 24, 2008

(54) ALIGNMENT SYSTEM AND METHOD FOR OVERLAPPING SUBSTRATES

(76) Inventors: Carl Picciotto, Palo Alto, CA (US); Jun Gao, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/625,500

(22) Filed: Jan. 22, 2007

(51) Int. Cl. G06K 9/32

(52) U.S. Cl. 382/294

(57) ABSTRACT

A system including a data acquisition system and a processing system is provided. The data acquisition system has a fixed position relative to a first substrate with a first pattern. The data acquisition system is configured to capture a reference frame that includes the first pattern and capture a first comparison frame that includes a second pattern on a second substrate, where the second pattern is substantially identical to the first pattern, subsequent to a relative position between the first and the second substrates being established such that the first and the second substrates to at least partially overlap. The processing system configured to calculate a first distance between the first pattern in the reference frame and the second pattern in the first comparison frame and determine whether the first distance indicates that the first pattern is substantially aligned with the second pattern.

### CROSS-REFERENCE TO RELATED APPLICATIONS

This application is related to U.S. patent application Ser. No. 10/930,206, filed Aug. 31, 2004, entitled DISPLACEMENT ESTIMATION SYSTEM AND METHOD, U.S. patent application Ser. No. 10/930,614, filed Aug. 31, 2004, entitled DISPLACEMENT ESTIMATION SYSTEM AND METHOD, and U.S. patent application Ser. No. 10/930,005, filed Aug. 31, 2004, entitled DISPLACEMENT ESTIMATION SYSTEM AND METHOD. Each of the above U.S. patent applications is assigned to the assignee of the present invention, and is hereby incorporated by reference herein.

### BACKGROUND

Various systems exist for the purpose of positioning one or more substrates in one or more locations to allow operations to be performed on the substrate or substrates. Some systems, such as some alignment systems, attempt to manually position substrates by directly aligning one or more patterns on the substrates with the goal of a zero-error alignment. Moire patterns or other particular patterns such as a box and a cross may be used for this purpose. However, the use of such patterns, particularly with respect to the precision gratings required to produce moire or diffraction patterns, may add costs to the manufacturing process.

With existing alignment systems, the positioning of substrates may be poorly quantized. In addition, due to process variations, alignment systems that compare patterns across different substrates may run into performance limitations. Further, the comparison of patterns across different substrates may involve shifting the substrates or repeated re-focusing of the alignment system. It would be desirable to be able to accurately quantize the position or positions of substrates.

### SUMMARY

One form of the present invention provides a system including a data acquisition system and a processing system. The data acquisition system has a fixed position relative to a first substrate with a first pattern. The data acquisition system is configured to capture a reference frame that includes the first pattern and capture a first comparison frame that includes a second pattern on a second substrate, where the second pattern is substantially identical to the first pattern, subsequent to a relative position between the first and the second substrates being established such that the first and the second substrates to at least partially overlap. The processing system configured to calculate a first distance between the first pattern in the reference frame and the second pattern in the first comparison frame and determine whether the first distance indicates that the first pattern is substantially aligned with the second pattern.

### BRIEF DESCRIPTION OF THE DRAWINGS

FIG. 1 is a block diagram illustrating one embodiment of an alignment system.

FIG. 2 is a flow chart illustrating one embodiment of a method for aligning identical patterns on at least partially overlapping substrates.

FIGS. 3A-3E are diagrams illustrating an example of aligning identical patterns on at least partially overlapping substrates using reference and comparison frames.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

A system and method for aligning identical patterns on at least partially overlapping substrates is described herein. The system and method contemplate iteratively calculating a distance between identical patterns on at least partially overlapping substrates and adjusting the relative position between the substrates using the patterns are aligned or substantially aligned.

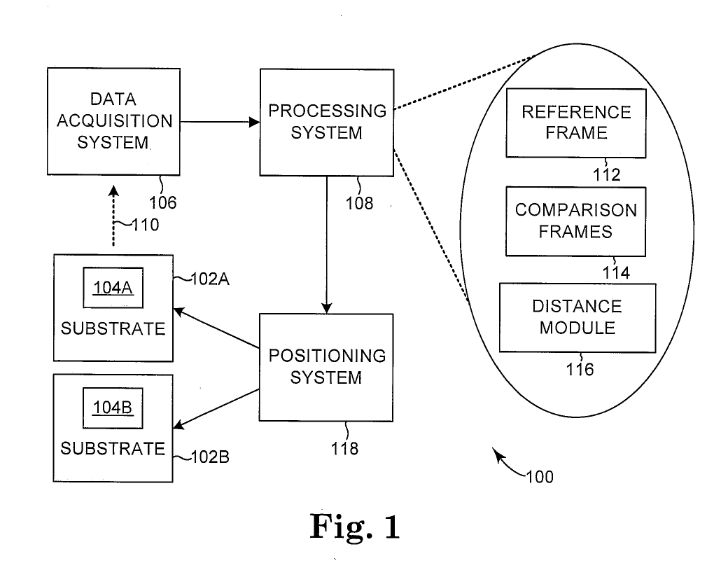

FIG. 1 is a block diagram illustrating one embodiment of an alignment system 100 configured to align substantially identical patterns 104A and 104B on at least partially overlapping substrates 102A and 102B, respectively. Alignment system 100 includes a data acquisition system 106, a processing system 108, and a positioning system 118. Processing system 108 includes a distance module 116 that is configured to calculate distances between patterns 104A and 104B using a reference frame 112 and one or more comparison frames 114.

Substrate 102A includes pattern 104A, and substrate 102B includes pattern 104B. Substrate 102A at least partially overlaps substrate 102B relative to data acquisition system 106. Substrate 102A is transparent with respect to data acquisition system 106 such that pattern 104B is detectable by data acquisition system 106 through substrate 102A. In one embodiment, substrate 102A is also transparent with respect to the human visual system such that a person may see through substrate 102A. In another embodiment, substrate 102A may not be transparent with respect to the human visual system but is transparent with respect to data acquisition system 106. Substrates 102B may also be transparent with respect to data acquisition system 106.

Substrates 102A and 102B may each be any suitable one, two, or three dimensional work object such as a silicon or other type of semiconductor wafer, paper, and a web of material such that pattern 104B of substrate 102B is detectable by data acquisition system 106 through substrate 102A. The term “web of material” covers both a web of material that carries objects (e.g., a conveyor) and the surface of a work object that is moveable relative to alignment system 100. Substrates 102A and 102B may comprise the same or different types of work objects.

Patterns 104A and 104B comprise an identical feature or an identical set of features formed on substrates 102A and 102B, respectively. For example, patterns 104A and 104B may include alignment marks formed on substrates 102A and 102B, respectively, features formed on substrates 102A and 102B as part of a manufacturing process associated with substrates 102A and 102B, respectively, or features formed on substrates 102A and 102B prior to a manufacturing process associated with substrates 102A and 102B, respectively. Patterns 104A and 104B may be readily visible to a human observer, visible only in response to an applied illumination field, or visible only using data acquisition system 106. When patterns 104A and 104B overlap or partially overlap relative to data acquisition system 106, one of pattern 104A and 104B may obscure or partially obscure the other pattern from data acquisition system 106.

Data acquisition system 106 comprises any suitable optical or non-optical system configured to acquire frames, such as reference frame 112 and comparison frames 114, from substrates 102A and 102B that identifies the relative locations of patterns 104A and 104B, respectively. Examples of optical systems include one or more cameras or other devices configured to optically capture reference frame 112 and comparison frames 114. Examples of non-optical systems include electron beam devices or other devices configured to capture reference frame 112 and comparison frames 114 using non-optical means.

Data acquisition system 106 is configured to capture frames that include pattern 104B, such that pattern 104B is detectable through substrate 102A, when substrate 102A at least partially overlaps pattern 104B. Data acquisition system 106 has a resolution and a scale appropriate for the type of substrates 102A and 102B. The resolution may be pixel, sub-pixel, or another suitable resolution, and the scale may be nanometer scale or another suitable resolution. Reference frame 112 and comparison frames 114 comprise any set of optical or non-optical images that comprise data that may be used to identify the relative locations of patterns 104A and 104B.

Data acquisition system 106 captures reference frame 112 and one or more comparison frames 114 and provides reference frame 112 and comparison frames 114 to processing system 108. Data acquisition system 106 captures reference frame 112 such that reference frame 112 includes either pattern 104A or pattern 104B. Data acquisition system 106 captures each comparison frame 114 such that each comparison frame 114 includes at least one of pattern 104A and pattern 104B. The relative position of data acquisition system 106 is fixed with respect to either substrate 102A or 102B.

Processing system 108 receives and stores reference frame 112 and comparison frames 114. Processing system 108 also processes reference frame 112 and comparison frames 114 using distance module 116. Using distance module 116, processing system 108 identifies or locates pattern 104A or 104B in reference frame 112 and identifies or locates pattern 104A or 104B in a comparison frame 114. Processing system 108 identifies or locates patterns 104A and 104B by searching for patterns 104A and 104B in selected regions of reference frame 112 and comparison frames 114. The regions may be selected from anticipated locations of patterns 104A and 104B. The regions may be searched using coarse searching algorithms to locate general regions where patterns 104A and 104B are located and then using fine searching algorithms to locate the specific regions where patterns 104A and 104B are located.

Processing system 108 calculates distances between pattern 104A and pattern 104B using reference frame 112 and comparison frames 114. For example, processing system 108 calculates a distance between pattern 104A in reference frame 112 and pattern 104B in a comparison frame 114 where reference frame 112 includes pattern 104A. Similarly, processing system 108 calculates a distance between pattern 104B in reference frame 112 and pattern 104A in a comparison frame 114 where reference frame 112 includes pattern 104B. Processing system 108 may calculate the distances to pixel or sub-pixel resolutions. Processing system 108 provides the distances to positioning system 118.

Distance module 116 may embody any suitable algorithm for calculating distances between patterns 104A and 104B. Suitable algorithms may include an image cross-correlation algorithm, a phase delay detection algorithm, or other displacement estimation algorithms.

With the image cross-correlation algorithm, distance module 116 uses image cross-correlations to calculate the distance. One example of an image cross-correlation algorithm is a nearest neighbor navigation algorithm. With the nearest neighbor navigation algorithm, distance module 116 uses image cross-correlations or comparison functions which approximate or parallel pixel-by-pixel correlation functions to calculate the distance. The nearest neighbor navigation algorithm uses very short correlation distances in calculating the distance. Additional details of nearest neighbor navigation algorithms may be found in U.S. Pat. No. 5,149,980 entitled “SUBSTRATE ADVANCE MEASUREMENT SYSTEM USING CROSS-CORRELATION OF LIGHT SENSOR ARRAY SIGNALS” listing Ertel et al. as inventors and U.S. Pat. No. 6,195,475 entitled “NAVIGATION SYSTEM FOR HANDHELD SCANNER” listing Beausoleil et al. as inventors. Each of these patents is assigned to the assignee of the present invention, and is hereby incorporated by reference herein.

With the phase delay detection algorithm (and other similar phase correlation methods), distance module 116 processes images converted to a frequency domain representation and calculates the distance through phase differences between the reference and comparison frames.

In certain embodiments, distance module 116 may calculate geometric extractions, such as centerlines, from patterns 104A and 104B in embodiments where patterns 104A and 104B are geometric patterns. In these embodiments, distance module 116 calculates the distances using the geometric extractions.

Functions performed by processing system 108 and/or distance module 116 may be implemented in hardware, software, firmware, or any combination thereof. The implementation may be via a microprocessor, programmable logic device, or state machine. Components of the present invention, e.g., distance module 116, may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

Positioning system 118 receives distances from processing system 108 and uses the distances to adjust substrates 102A and 102B relative to one another to align or substantially align patterns 104A and 104B. In one embodiment, positioning system 118 adjusts substrates 102A and 102B relative to one another by adjusting only the position of substrate 102B. In another embodiment, positioning system 118 adjusts substrates 102A and 102B relative to one another by adjusting only the position of substrate 102A. In a further embodiment, positioning system 118 adjusts substrates 102A and 102B relative to one another by adjusting the position of substrate 102A and the position of substrate 102B.

As noted above, data acquisition system 106 is fixed relative to substrate 102A or 102B. Accordingly, positioning system 118 may also adjust the relative position between data acquisition system 106 and the substrate that is not in a fixed relative position to data acquisition system 106. For example, if the relative position between data acquisition system 106 and substrate 102A is fixed, then positioning system 118 may adjust both data acquisition system 106 and substrate 102A to adjust the relative position between substrate 102A and substrate 102B.

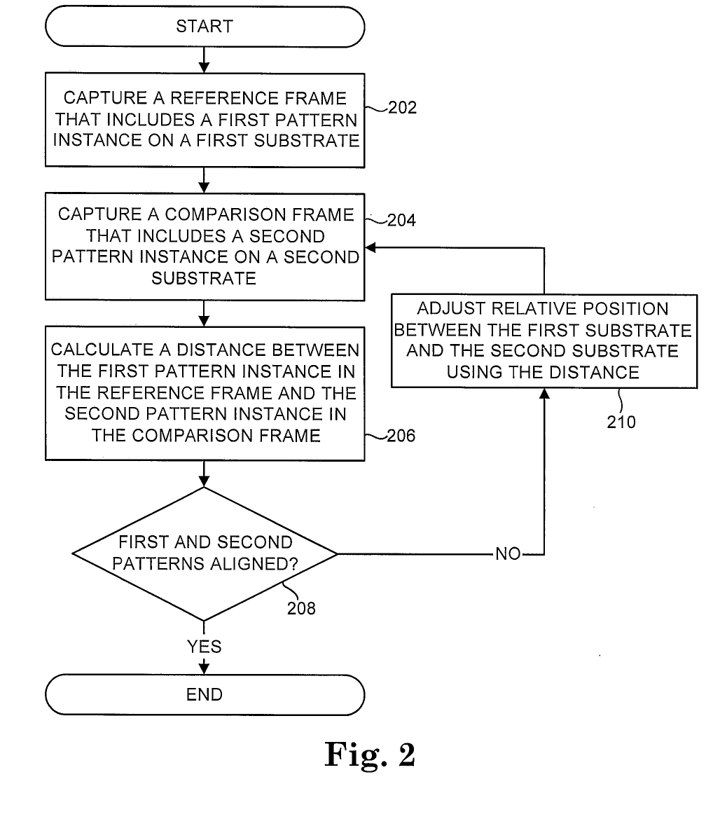

FIG. 2 is a flow chart illustrating an embodiment of a method for aligning identical patterns on at least partially overlapping substrates. The method shown in FIG. 2 will be described with reference to alignment system 100.

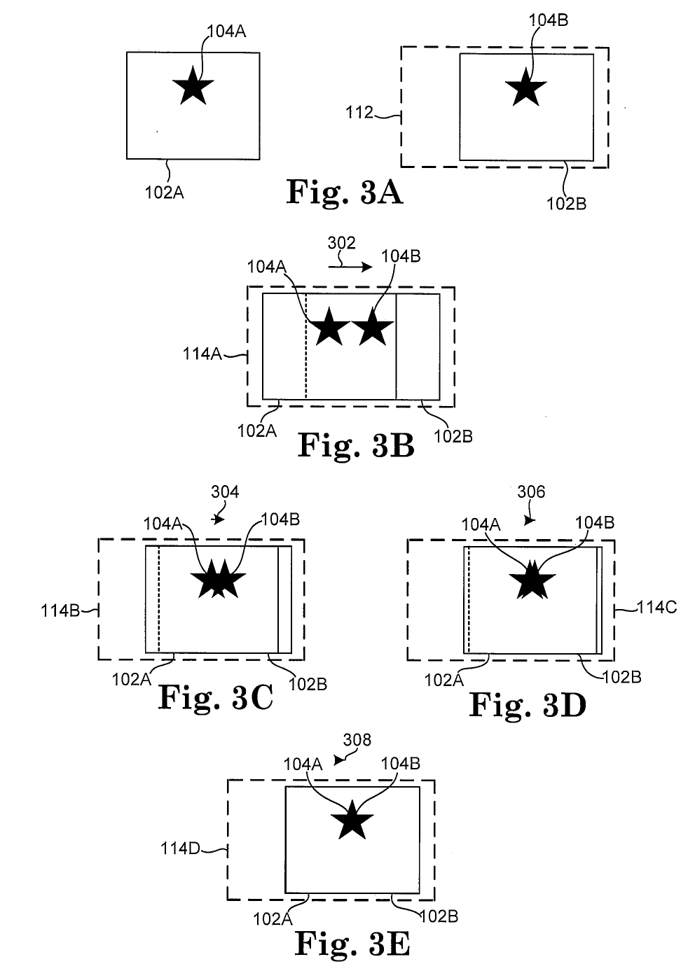

The method shown in FIG. 2 will be also described with reference to the example shown in FIGS. 3A-3E. FIGS. 3A-3E are diagrams illustrating an example of aligning identical patterns 104A and 104B on at least partially overlapping substrates 102A and 102B using reference frame 112 and comparison frames 114A-114D from the perspective of data acquisition system 106.

As shown in the example of FIGS. 3A-3E, the relative position between data acquisition system 106 and substrate 102B is fixed such that positioning system 118 adjusts only the position of substrate 102A to adjust the relative position between substrates 102A and 102B. In other examples, positioning system 118 adjusts the position of substrate 102B and data acquisition system 106 as a single unit (i.e., by maintaining the fixed relative position between substrate 102B and data acquisition system 106) to adjust the relative position between substrates 102A and 102B.

Referring to FIGS. 1, 2 and 3A-3E, a reference frame that includes a first pattern on a first substrate is captured using data acquisition system 106 as indicated in a block 202. Data acquisition system 106 captures reference frame 112 such that reference frame 112 includes either pattern 104A or pattern 104B. FIG. 3A illustrates the relative position of substrates 102A and 102B at a first time. In the example of FIG. 3A, data acquisition system 106 data acquisition system 106 has a fixed position relative to substrate 102B and captures reference frame 112 such that reference frame 112 includes pattern 104B.

A comparison frame that includes a second pattern on a second substrate is captured using data acquisition system 106 as indicated in a block 204. Data acquisition system 106 captures a comparison frame 114 such that the comparison frame 114 includes either pattern 104A or pattern 104B. Subsequent to the first time shown in FIG. 3A, positioning system 118 adjusts the position of substrate 102A such that substrate 102A partially overlaps with substrate 102B as shown in FIG. 3B at a second time. In the example of FIG. 3B, data acquisition system 106 captures comparison frame 114A such that comparison frame 114A includes pattern 104A.

A distance is calculated between the first pattern in the reference frame and the second pattern in the comparison frame as indicated in a block 206. Processing system 108 calculates a distance between pattern 104A in comparison frame 114A and pattern 104B in reference frame 112. In the example of FIG. 3B, processing system 108 calculates a distance 302 between pattern 104A in comparison frame 114A and pattern 104B in reference frame 112.

A determination is made as to whether the first and the second patterns are aligned as indicated in a block 208. Processing system 108 determine whether patterns 104A and 104B are aligned or substantially aligned by comparing the distance calculated in block 206 to a threshold value. The threshold value may be zero or near zero according to one or more embodiments. When patterns 104A and 104B align or substantially align, patterns 104A and 104B appear as a single pattern from the perspective of data acquisition system 106. If the first and the second patterns are aligned as determined by processing system 108, then the method ends.

If the first and the second patterns are not aligned, then the relative position between the first substrate and the second substrate is adjusted using the distance as indicated in a block 210. Positioning system 118 adjusts the relative position of substrates 102A and 102B by adjusting the position of substrate 102A, the position of substrate 102B, or the positions of both substrates 102A and 102B in any suitable way. In the example of FIG. 3B, processing system 108 determines that patterns 104A and 104B are not aligned at the second time. As shown at a third time in the example of FIGS. 3C, positioning system 118 adjusts the relative position of substrates 102A and 102B between the second and the third time by moving substrate 102A in the direction indicated by distance 302.

The method repeats the functions of blocks 204, 206, 208, and, if necessary, 210 until patterns 104A and 104B are aligned. In the example of FIG. 3C, data acquisition system 106 captures comparison frame 114B and processing system 108 calculates a distance 304 between pattern 104A in comparison frame 114B and pattern 104B in reference frame 112 as indicated in blocks 404 and 406. At block 408, processing system 108 determines that patterns 104A and 104B are not aligned and causes positioning system 118 to adjust the relative position of substrates 102A and 102B by moving substrate 102A in the direction indicated by distance 304 subsequent to the third time.

At a fourth time shown in the example of FIG. 3D, data acquisition system 106 captures comparison frame 114C and processing system 108 calculates distance 306 between pattern 104A in comparison frame 114B and pattern 104B in reference frame 112 as indicated in blocks 404 and 406. At block 408, processing system 108 determines that patterns 104A and 104B are not aligned and causes positioning system 118 to adjust the relative position of substrates 102A and 102B subsequent to the fourth time by moving substrate 102A in the direction indicated by distance 306.

At a fifth time shown in the example of FIG. 3E, data acquisition system 106 captures comparison frame 114D and processing system 108 calculates distance 308 between pattern 104A in comparison frame 114B and pattern 104B in reference frame 112 as indicated in blocks 404 and 406. At block 408, processing system 108 determines that pattern 104A aligns or substantially aligns with pattern 104B. Accordingly, patterns 104A and 104B appear as a single pattern from the perspective of data acquisition system 106 at the fifth time shown in FIG. 3E.

In one embodiment, positioning system 118 includes a coarse positioning system (not shown) that is configured to adjust the relative position between substrates 102A and 102B until the distance between pattern instances 104A and 104B is below a threshold such as a threshold where pattern instances 104A and 104B partially overlap from the perspective of data acquisition system 106. In the example of FIGS. 3A-3E, for example, the coarse positioning system may adjust the relative position of substrates 102A and 102B prior to the second time shown in FIG. 3B and prior to the third time shown in FIG. 3C.

In the example of FIGS. 3A-3E, positioning system 118 moves substrate 102A relative to substrate 102B. In other embodiments, positioning system 118 may move substrate 102B (along with data acquisition system 106) relative to substrate 102A or positioning system 118 may move substrates 102A and 102B relative to one another.

Alignment system 100 may be used in a wide variety of applications. The applications include lithography such as optical lithography, imprint or contact lithography, and nanoimprint lithography.

Embodiments described herein may provide advantages over previous alignment systems. For example, alignment of patterns may be achieved where one of the patterns obscures the other of the patterns. The alignment may be achieved without separating the patterns or repeatedly changing the focus of a data acquisition system. In addition, the use of costly moire patterns and diffraction patterns with gratings in alignment systems may be avoided. Further, distances between patterns are well quantized even where the patterns occlude each other.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system comprising:
a data acquisition system having a fixed position relative to a first substrate with a first pattern, the data acquisition system configured to capture a reference frame that includes the first pattern, and the data acquisition system configured to capture a first comparison frame that includes a second pattern on a second substrate, the second pattern being substantially identical to the first pattern, subsequent to a relative position between the first and the second substrates being established such that the first and the second substrates to at least partially overlap; and
a processing system configured to calculate a first distance between the first pattern in the reference frame and the second pattern in the first comparison frame and determine whether the first distance indicates that the first pattern is substantially aligned with the second pattern.

2. The system of claim 1 wherein the processing system is configured to cause the relative position between the first and the second substrates to be adjusted using the first distance in response to determining that the first pattern and the second pattern are not substantially aligned.

3. The system of claim 2 wherein the data acquisition system is configured to capture a second comparison frame that includes the second pattern subsequent to the relative position being adjusted, and wherein the processing system is configured to calculate a second distance between the first pattern in the reference frame and the second pattern in the second comparison frame and determine whether the second distance indicates that the first pattern is substantially aligned with the second pattern.

4. The system of claim 1 wherein the second substrate is between the data acquisition system and the first substrate.

5. The system of claim 1 wherein the first substrate is between the data acquisition system and the second substrate.

6. The system of claim 1 wherein the data acquisition system is configured to capture the reference frame prior to the relative position being established.

7. The system of claim 1 wherein the first pattern at least partially overlaps with the second pattern with respect to the data acquisition system.

8. The system of claim 1 wherein at least one of the first substrate and the second substrate is transparent with respect to the data acquisition system.

9. The system of claim 1 wherein the data acquisition system includes an optical system.

10. The system of claim 1 wherein the data acquisition system includes a non-optical system.

11. A method comprising:
capturing a reference frame that includes a first pattern on a first substrate using a data acquisition system having a fixed position relative to the first substrate;
capturing a comparison frame that includes a second pattern on a second substrate that at least partially overlaps with the first substrate using the data acquisition system, the second pattern being substantially identical to the first pattern;
calculating a distance between the first pattern in the reference frame and the second pattern in the comparison frame
adjusting a relative position between the first and the second substrates using the distance; and
repeating the steps of capturing the comparison frame, calculating the distance, and adjusting the relative position until the first pattern is substantially aligned with the second pattern.

12. The method of claim 11 further comprising:
calculating the distance using an image cross-correlation algorithm.

13. The method of claim 11 further comprising:
calculating the distance using a phase delay detection algorithm.

14. The method of claim 11 wherein the first pattern at least partially overlaps with the second pattern with respect to the data acquisition system.

15. The method of claim 11 wherein at least one of the first substrate and the second substrate is transparent with respect to the data acquisition system.

16. A system comprising:
a data acquisition system having a fixed position relative to a first substrate with a first pattern;
a positioning system configured to adjust a relative position of the first substrate and a second substrate with a second pattern such that the first and second substrates at least partially overlap relative to the data acquisition system, the first and the second patterns being substantially identical; and
a processing system;
wherein the data acquisition system is configured to capture a reference frame that includes the first pattern, wherein the data acquisition system is configured to capture a comparison frame that includes the second pattern, and wherein the processing system is configured to determine whether the first pattern is substantially aligned with the second pattern by calculating a distance between the first pattern in the reference frame and the second pattern in the comparison frame.

17. The system of claim 16 wherein the positioning system is configured to adjust the relative position by adjusting a position of the first substrate and the data acquisition system while maintaining the fixed position between the first substrate and the data acquisition system.

18. The system of claim 16 wherein the positioning system is configured to adjust the relative position by adjusting a position of the second substrate.

19. The system of claim 16 wherein the positioning system is configured to adjust the relative position by adjusting a first position of the first substrate and a second position of the second substrate.

20. The system of claim 16 wherein the processing system is configured to calculate the distance using one of an image cross-correlation algorithm and a phase delay detection algorithm.
